(19) United States
(12) Patent Application Publication
(10) Pub. No.: US 2016/0112318 A1
(43) Pub. Date: Apr. 21, 2016

(54) INFORMATION PROCESSING SYSTEM, METHOD, AND INFORMATION PROCESSING APPARATUS

(71) Applicant: FUJITSU LIMITED, Kawasaki-shi (JP)

(72) Inventor: Teruo TANIMOTO, Kawasaki (JP)

(73) Assignee: FUJITSU LIMITED, Kawasaki-shi (JP)

(21) Appl. No.: 14/884,031

(22) Filed: Oct. 15, 2015

(30) Foreign Application Priority Data
Oct. 21, 2014 (JP) 2014-214645

(51) Int. Cl. H04L 12/741; H04L 29/08; H04L 12/721

(52) U.S. Cl. CPC H04L 45/745; H04L 45/34; H04L 69/324

(57) ABSTRACT

A system includes a first apparatus coupled to a second apparatus through communication paths. The first apparatus generates leading packets, each including destination information to identify the second apparatus in leading data among data read from a first memory based on a memory transfer request the second apparatus being a destination of the data specified by the memory transfer request, transmits the leading packets to the communication paths, respectively, generates last packets including the destination information in last data among the data read from the first memory based on the memory transfer request, and transmits the last packets to the communication paths, respectively. The second apparatus counts the last packets received through the communication paths, and control to store the last data included in the received last packets in a second memory when the number of the last packets counted coincides with the number of the communication paths.

### CROSS-REFERENCE TO RELATED APPLICATION

This application is based upon and claims the benefit of priority of the prior Japanese Patent Application No. 2014-214645, filed on Oct. 21, 2014, the entire contents of which are incorporated herein by reference.

### FIELD

The embodiments discussed herein are related to an information processing system, a method, and an information processing apparatus.

### BACKGROUND

A data transmission technology to transmit data between storage devices included in information processing apparatuses without putting a load on an arithmetic processing device such as a central processing unit (CPU) has recently been adopted in an information processing system. As this kind of data transmission technology, a remote direct memory access (RDMA) technology and the like have been known.

In a data processing apparatus adopting the RDMA technology, data transmission efficiency is improved by selecting a combination of communication paths that minimizes a data delay amount, among a plurality of communication paths.

Moreover, in a network system to transmit and receive packets through a network, there has been proposed a technique to process a control packet and a data packet by using different processing paths. Furthermore, in a communication network coupling apparatus, there has been proposed a technique to distribute data transferred from a telephone switching network to a plurality of signal processing units, and to transfer the data processed by the signal processing units to an Internet protocol network.

Japanese Laid-open Patent Publication No. 2008-301002, Japanese National Publication of International Patent Application No. 2008-517565 and Japanese Laid-open Patent Publication No. 2001-298491 are known as examples of the related art.

### SUMMARY

According to an aspect of the invention, an information processing system includes a plurality of information processing apparatuses coupled to each other through a plurality of communication paths, the information processing apparatuses including at least a first information processing apparatus and a second information processing apparatus. The first information processing apparatus includes a first memory, a first processor, and a first controller. The first controller is configured to: generate a plurality of leading packets, each including destination information to identify the second information processing apparatus in leading data among data read from the first memory based on a memory transfer request from the first processor, the second information processing apparatus being a destination of the data specified by the memory transfer request, transmit the plurality of leading packets to the plurality of communication paths, respectively, generate a plurality of last packets including the destination information in last data among the data read from the first memory based on the memory transfer request, and transmit the plurality of last packets to the plurality of communication paths, respectively. The second information processing apparatus includes a second memory and a second controller configured to: count the last packets received through the plurality of communication paths, and control to store the last data included in the received last packets in the second memory when the number of the last packets counted coincides with the number of the plurality of communication paths.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an embodiment;

FIG. 2 illustrates another embodiment;

FIG. 3 illustrates an example of a RDMA module illustrated in FIG. 2;

FIG. 4 illustrates an example of a routing table illustrated in FIG. 3;

FIG. 5 illustrates an example of write processing between nodes illustrated in FIG. 2;

FIG. 6 illustrates an example of read processing between nodes illustrated in FIG. 2;

FIG. 7 illustrates an example of a format of a packet illustrated in FIGS. 5 and 6;

FIG. 8 illustrates an example of a packet code illustrated in FIG. 7;

FIG. 9 illustrates an example of operations of the RDMA module that is a data source in the write processing illustrated in FIG. 5;

FIG. 10 illustrates an example of operations of the RDMA module that is a data destination in the write processing illustrated in FIG. 5;

FIG. 11 illustrates an example of operations of the RDMA module that is a data destination in the read processing illustrated in FIG. 6;

FIG. 12 illustrates an example of operations of the RDMA module that is a data source in the read processing illustrated in FIG. 6;

FIG. 13 illustrates an example of operations of a packet transmission unit that executes S500 illustrated in FIGS. 9 and 12;

FIG. 14 illustrates an example of operations of a packet reception unit that executes S600 illustrated in FIGS. 10 and 11; and

FIG. 15 illustrates an example of evaluation of data transfer performance in the information processing system illustrated in FIG. 2.

### DESCRIPTION OF EMBODIMENTS

When packets are transmitted using communication paths, a difference in transmission delay between the communication paths may switch the reception order of the packets by a reception device with respect to the transmission order of the packets by a transmission device. Here, the order of the packets is identified by a serial number and the like stored in each of the packets. When switching of the reception order of the packets hinders normal execution of processing of data contained in the packets, the reception device detects a transmission error based on the detection of the switching of the reception order of the packets, and discards the received packets. The discarded packets are retransmitted from the transmission device to the reception device by retransmission processing. When the transmission error is generated by the difference in transmission delay between the communication paths, the retransmission processing is repeatedly performed, and thus transmission efficiency is reduced.

It is an object of the embodiments to suppress reduction in transmission efficiency of packets to be transmitted using communication paths.

Hereinafter, the embodiments are described with reference to the drawings.

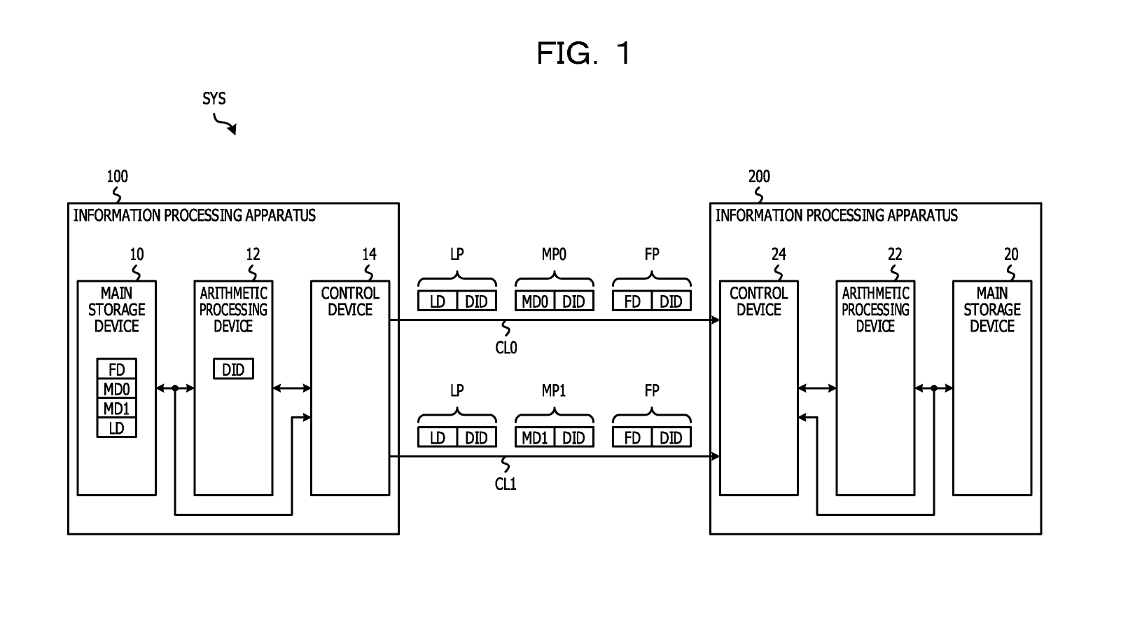

FIG. 1 illustrates an embodiment. An information processing system SYS illustrated in FIG. 1 includes information processing apparatuses 100 and 200 coupled to each other through communication paths CL (CL0 and CL1). The information processing apparatus 100 is a server or the like, and includes a main storage device 10, an arithmetic processing device 12, and a control device 14. The information processing apparatus 200 is a server or the like, and includes a main storage device 20, an arithmetic processing device 22, and a control device 24. Each of the main storage devices 10 and 20 is a memory module or the like including a dynamic random access memory (DRAM). Each of the arithmetic processing devices 12 and 22 is a processor such as a CPU.

Note that the number of the communication paths CL coupling between the information processing apparatuses 100 and 200 may be three or more. The number of the information processing apparatuses to be coupled to each other through the communication paths CL may be three or more. In this case, the communication paths CL coupling a pair of information processing apparatuses may be the same as, different from or partially different from the communication paths CL coupling another pair of information processing apparatuses.

The main storage device 10 stores data FD, MD0, MD1, and LD to be transmitted to the information processing apparatus 200. The arithmetic processing device 12 outputs, to the control device 14, a memory transfer request to transfer stream data to the main storage device 20 in the information processing apparatus 200, the stream data including the data FD, MD0, MD1, and LD stored in the main storage device 10. For example, the stream data is a basic unit of data to be processed by the arithmetic processing device 22.

The control device 14 generates first packets (leading packets) FP, each having destination information DID attached to first data (leading data) FD to be read from the main storage device 10, based on the memory transfer request from the arithmetic processing device 12, the destination information DID identifying the information processing apparatus 200 to be a destination. The destination information DID is contained in the memory transfer request to be generated by the arithmetic processing device 12. The control device 14 transmits the generated first packets FP to the communication paths CL0 and CL1, respectively. Next, the control device 14 generates middle packets MP (MP0 and MP1), each having the destination information DID attached to each of middle data MD (MD0 and MD1) to be read from the main storage device 10. Then, the control device 14 transmits the generated middle packets MP0 and MP1 to the communication paths CL0 and CL1, respectively. For example, the control device 14 sequentially selects the communication paths CL0 and CL1 using a round-robin technique or the like, and transmits the middle packets MP0 and MP1 to the selected communication path CL. Thus, the middle packets MP may be transmitted in parallel to the communication paths CL. As a result, transmission efficiency is improved compared with the case where the middle packets MP are transmitted using a single communication path CL.

Also, the control device 14 generates last packets LP, each having the destination information DID attached to last data LD to be read from the main storage device 10, and transmits the generated last packets LP to the communication paths CL0 and CL1, respectively.

Meanwhile, the control device 24 in the information processing apparatus 200 receives the first packets FP, the middle packets MP0 and MP1, and the last packets LP through the communication paths CL0 and CL1. The control device 24 causes the main storage device 20 to store the first data FD contained in any of the first packets FP received. The control device 24 causes the main storage device 20 to store the middle data MD0 and MD1 contained, respectively, in the middle packets MP0 and MP1 received.

Also, when a count result (“2” in FIG. 1) of counting the number of the last packets LP coincides with the number of the communication paths CL0 and CL1, the control device 24 causes the main storage device 20 to store the last data LD contained in any of the last packets LP received. In other words, the control device 24 determines the completion of transfer of the stream data, based on the confirmation of the reception of all the last packets LP transmitted by the control device 14, and causes the main storage device 20 to store the last data LD. Thereafter, the arithmetic processing device 22 executes arithmetic processing and the like using the stream data containing the first data FD, middle data MD0 and MD1 and last data LD stored in the main storage device 20.

It is assumed, for example, that a transmission delay of the communication path CL0 is larger than that of the communication path CL1. When receiving the last packet LP through the communication path CL1 before receiving the middle packet MP0 through the communication path CL0, the control device 24 does not determine the completion of the transfer of the stream data, based on the last packet LP. When receiving the last packet LP from the communication path CL0 after receiving the middle packet MP0, the control device 24 determines the completion of the transfer of the stream data.

Therefore, even when the transmission delay of the communication path CL0 is larger than that of the communication path CL1, a problem is suppressed that the middle data MD0 contained in the middle packet MP0 is not stored in the main storage device 20. In other words, a transmission error due to the reception of the last packet LP before the middle packet MP0 is suppressed from occurring.

As a result, even when the transmission delay differs between the communication paths CL, the middle packets MP may be transmitted in parallel using the communication paths CL without generating any transmission error. More specifically, by transmitting the first packets FP and the last packets LP to the communication paths CL, the middle packets MP0 and MP1 may be transmitted in parallel to the communication paths without generating any transmission error. Thus, occurrence of transmission errors is suppressed also when the packets FP, MP0, MP1, and LP are transmitted using the communication paths CL. Accordingly, reduction in transmission efficiency of the packets FP, MP0, MP1, and LP is suppressed.

Note that FIG. 1 illustrates an example where the stream data is transferred to the main storage device 20 from the main storage device 10. However, the stream data may be transferred from the main storage device 20 to the main storage device 10. In this case, the control device 24 includes not only a function to receive the packets FP, MP0, MP1, and LP but also a function (the function of the control device 14) to transmit the packets FP, MP0, MP1, and LP. The control device 14 includes not only a function to transmit the packets FP, MP0, MP1, and LP but also a function (the function of the control device 24) to receive the packets FP, MP0, MP1, and LP. The transfer of the stream data from the main storage device 20 to the main storage device 10 may be executed using the communication paths CL0 and CL1, or may be executed using a communication path CL different from the communication paths CL0 and CL1.

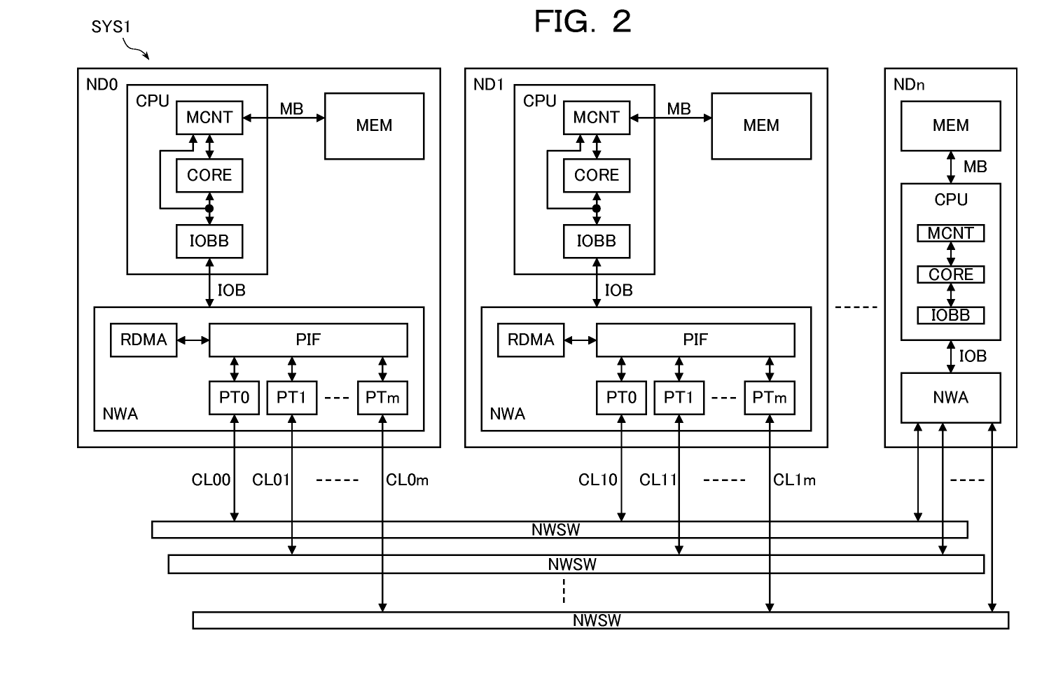

FIG. 2 illustrates another embodiment. An information processing system SYS1 illustrated in FIG. 2 includes n−1 (n is an integer not less than 3) nodes ND (ND0, ND1, . . . , NDn). Each of the nodes ND is an example of the information processing apparatus.

The node ND0 is coupled to network switches NWSW through m−1 (m is an integer not less than 3) communication paths CL (CL00, CL01, . . . , CL0m). The node ND1 is coupled to the network switches NWSW through m−1 communication paths CL (CL10, CL11, . . . , CL1m). The node NDn is coupled to the network switches NWSW through m−1 communication paths CL. Since the nodes ND0, ND1, . . . , NDn have the same or similar configuration, the configuration of the node ND0 is described below.

The node ND0 includes a CPU, a main storage device MEM and a network adapter NWA. The CPU is an example of the arithmetic processing device. The main storage device MEM is a memory module or the like including a DRAM. The network adapter NWA is mounted in the node ND0 as a network interface card (NIC), for example.

The CPU includes a core CORE to execute arithmetic processing, a memory controller MCNT and an input-output bus bridge IOBB. The memory controller MCNT is coupled to the main storage device MEM through a memory bus MB, and controls access to the main storage device MEM based on an instruction from the CPU or a control device RDMA in the network adapter NWA. Note that the CPU may include a cache memory that stores some of information stored in the main storage device MEM. The input-output bus bridge IOBB couples an input-output bus IOB, which is coupled to the network adapter NWA, to a bus of the core CORE or a bus of the memory controller MCNT.

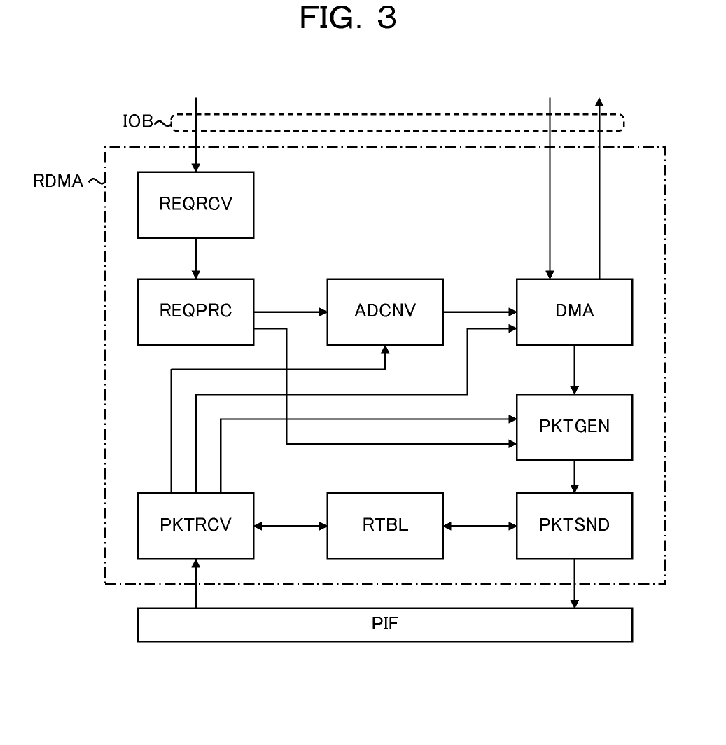

The network adapter NWA includes the control device RDMA, a port interface PIF and m ports PT (PT0, PT1, . . . , PTm). The control device RDMA has a function to directly transfer data, without using the core CORE, between the main storage device MEM included in the node ND0 and the main storage device MEM included in another node ND (ND1 or the like). In the following description, the control device RDMA is also called an RDMA module. FIG. 3 illustrates an example of the RDMA module.

The port interface PIF outputs packets to be outputted from the RDMA module to the ports PT0 to PTm based on an instruction of the RDMA module, and outputs packets to be transmitted through the communication paths CL00 to CL0m to the RDMA module. Each of the ports PT is coupled to any of the ports PT in another node ND through the communication path CL and the network switch NWSW.

FIG. 3 illustrates an example of the RDMA module illustrated in FIG. 2. The RDMA module includes a request reception unit REQRCV, a request processing unit REQPRC, an address conversion unit ADCNV, and a transfer unit DMA. The RDMA module also includes a packet generation unit PKTGEN, a packet transmission unit PKTSND, a packet reception unit PKTRCV and a routing table RTBL.

The request reception unit REQRCV receives a write request or a read request from the CPU through the input-output bus IOB, and outputs the received request to the request processing unit REQPRC. The write request and the read request are an example of the memory transfer request.

The write request is issued by the CPU in the own node ND when transferring the data stored in the main storage device MEM in the own node ND to the main storage device MEM in another node ND. The write request contains a data length of the data, an identification (ID) that is identification information to identify the own node ND that is a source of the data, and an ID of the node ND that is a destination of the data. The write request also contains identification information to identify a memory region in the main storage device MEM of the data source, a first virtual memory address of the data source, identification information to identify a memory region in the main storage device MEM of the data destination, and a first virtual memory address (a leading virtual memory address) of the data destination.

The read request is issued by the CPU in the own node ND when transferring the data stored in the main storage device MEM in another node ND to the main storage device MEM in the own node ND. The read request contains a data length of the data, an ID of the node ND that is a source of the data, and an ID of the own node ND that is a destination of the data. The read request also contains identification information to identify a memory region in the main storage device MEM of the data source, a first virtual memory address of the data source, identification information to identify a memory region in the main storage device MEM of the data destination, and a first virtual memory address of the data destination.

The request processing unit REQPRC receives the write request and the read request from the request reception unit REQRCV, and decodes the received write request and read request to extract the information contained in the write request and the read request. Upon receipt of the write request, the request processing unit REQPRC outputs the data length of the data, the identification information to identify the memory region in the main storage device MEM of the data source, and the first virtual memory address of the data source to the address conversion unit ADCNV. The request processing unit REQPRC also outputs the ID of the node ND of the data source, the ID of the node ND of the data destination and the data length of the data to the packet generation unit PKTGEN. The request processing unit REQPRC further outputs the identification information to identify the memory region in the main storage device MEM of the data destination and the first virtual memory address of the data destination to the packet generation unit PKTGEN.

Meanwhile, upon receipt of the read request, the request processing unit REQPRC outputs the ID of the node ND of the data source, the ID of the node ND of the data destination and the data length of the data to the packet generation unit PKTGEN. The request processing unit REQPRC also outputs the identification information to identify the memory region in the main storage device MEM of the data source and the first virtual memory address of the data source to the packet generation unit PKTGEN. The request processing unit REQPRC further outputs the identification information to identify the memory region in the main storage device MEM of the data destination and the first virtual memory address of the data destination to the packet generation unit PKTGEN.

When the write request is issued by the CPU in the own node ND, the address conversion unit ADCNV generates a physical address of the main storage device MEM, from which data is to be read, based on the identification information to identify the memory region in the main storage device MEM in the own node ND and the first virtual memory address. Then, the address conversion unit ADCNV outputs the generated physical address and the data length of the data to the transfer unit DMA.

When reading the data from the main storage device MEM in the own node ND based on the read request from another node ND, the address conversion unit ADCNV receives the identification information to identify the memory region in the main storage device MEM and the first virtual memory address from the packet reception unit PKTRCV. Then, the address conversion unit ADCNV generates a physical address of the main storage device MEM to store the data in the own node ND, based on the identification information and the first virtual memory address, and outputs the generated physical address to the transfer unit DMA.

When the write request is issued by the CPU in the own node ND, the transfer unit DMA executes direct memory access (DMA) transfer to read data from the main storage device MEM in the own node ND, and outputs the read data to the packet generation unit PKTGEN. Moreover, when the read request is issued by the CPU in another node ND, the transfer unit DMA executes DMA transfer to store the data, which is contained in the packet received by the packet reception unit PKTRCV, in the main storage device MEM in the own node ND.

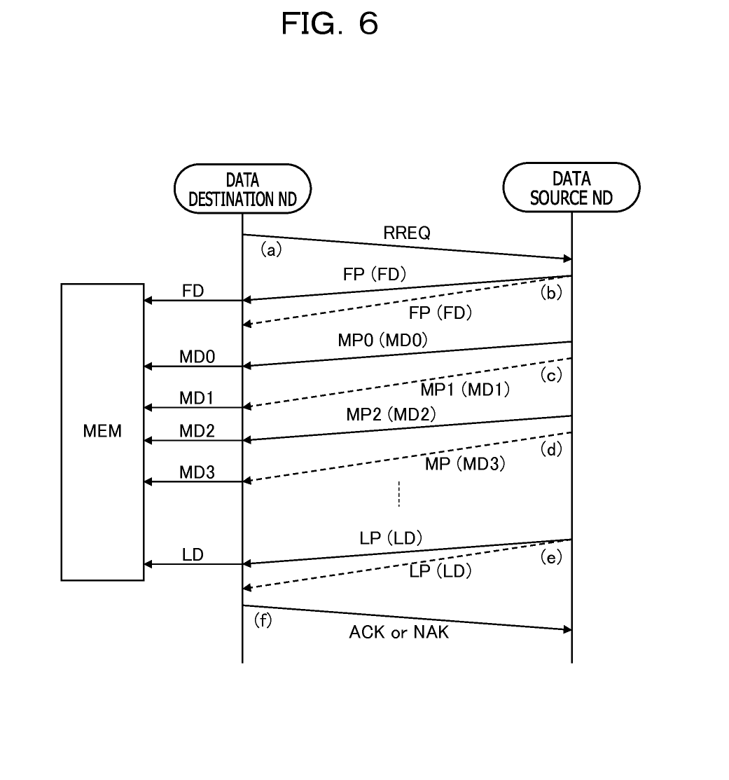

When the write request is issued by the CPU in the own node ND, the packet generation unit PKTGEN generates a packet to transfer the data transferred from the transfer unit DMA to the node ND that is a transfer destination of the data, and outputs the generated packet to the packet transmission unit PKTSND. Also, when the read request is issued by the CPU in the own node ND, the packet generation unit PKTGEN generates a read request packet (RREQ in FIG. 6) to read the data from the node ND that is a transfer source of the data, and outputs the generated packet to the packet transmission unit PKTSND. Furthermore, when the read request is issued by the CPU in the own node ND, the packet generation unit PKTGEN generates a receipt acknowledgement packet indicating whether or not the packet reception unit PKTRCV has normally received the data from the node ND that is the data transfer source. Then, the packet generation unit PKTGEN outputs the generated packet to the packet transmission unit PKTSND.

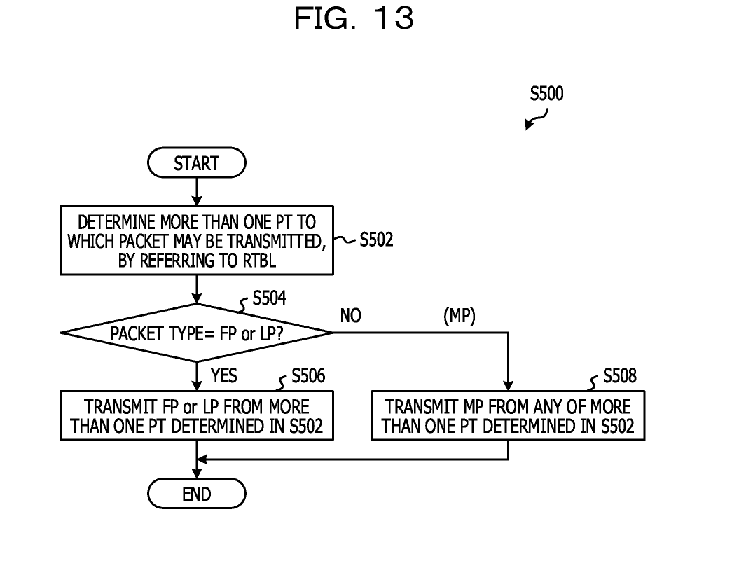

The packet transmission unit PKTSND determines a port PT (FIG. 2) to which a packet is to be transmitted, by referring to the routing table RTBL, based on the ID of the destination node ND contained in the packet received from the packet generation unit PKTGEN. Then, the packet transmission unit PKTSND transmits the packet to the determined port PT through the port interface unit PIF. The transmitted packet is transmitted to the destination node ND through the port interface unit PIF, the port PT, the communication path CL, the network switch NWSW, and the communication path CL illustrated in FIG. 2. FIG. 13 illustrates an example of operations of the packet transmission unit PKTSND.

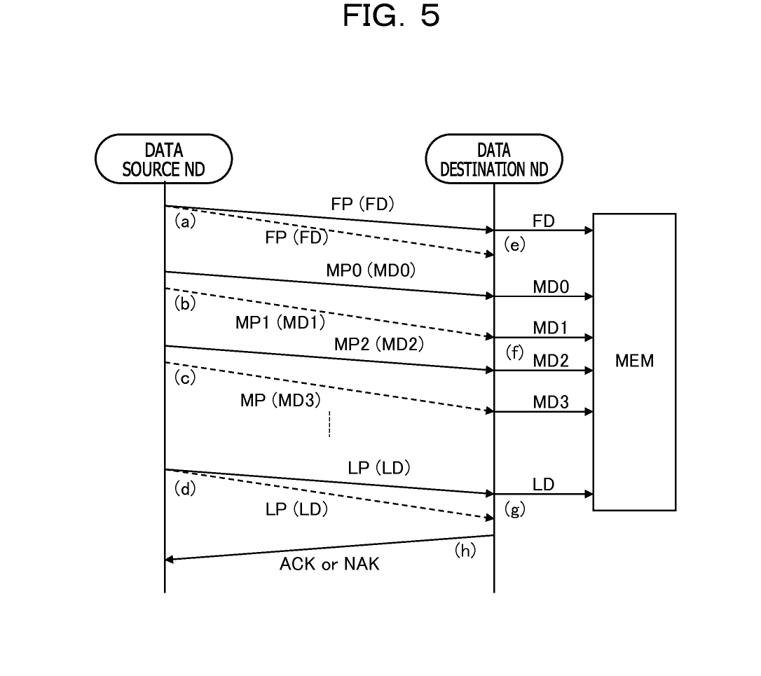

When the read request is issued by the CPU in the own node ND, the packet reception unit PKTRCV receives the packet received from the data source node ND. Then, the packet reception unit PKTRCV outputs the identification information to identify the memory region in the main storage device MEM of the data destination and the first virtual memory address of the data destination, which are contained in the received packet, to the address conversion unit ADCNV. The packet reception unit PKTRCV outputs the data contained in the packet received from the data source node ND to the transfer unit DMA. The packet received from the data source node ND is any of the first packet FP, the middle packet MP, and the last packet LP illustrated in FIGS. 5 and 6.

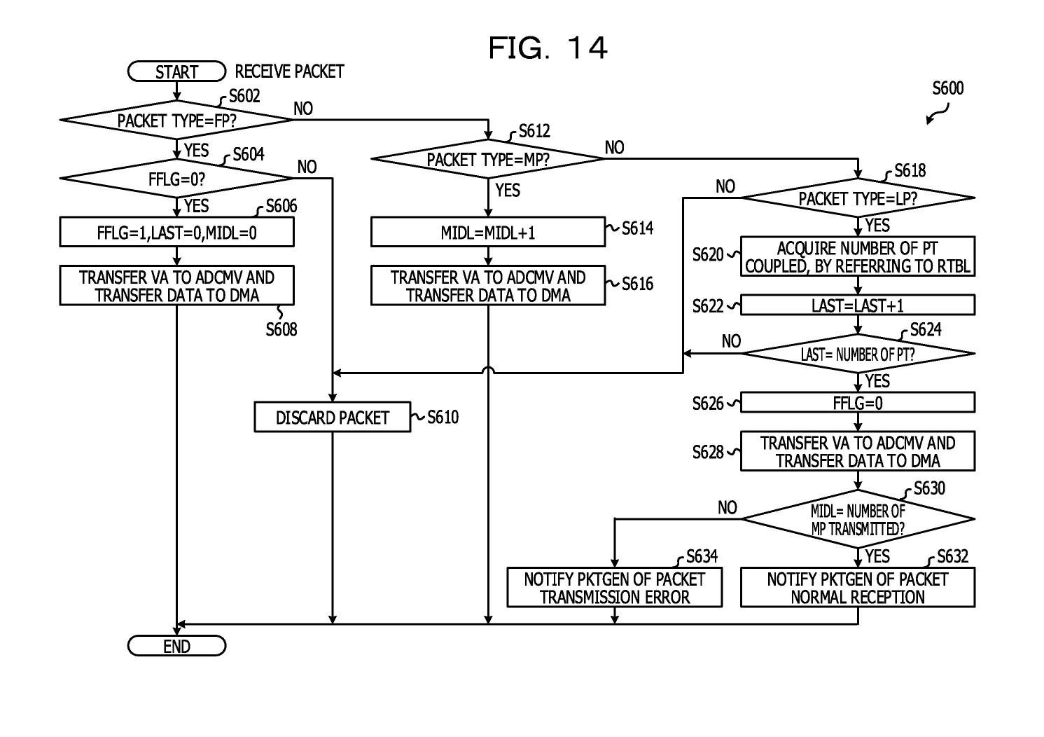

Upon receipt of the last packet LP from the data source node ND, the packet reception unit PKTRCV obtains the number of the ports PT used to receive the packet, by referring to the routing table RTBL. Then, the packet reception unit PKTRCV outputs information indicating normal reception (ACK) or reception error (NAK) to the packet generation unit PKTGEN, based on a result of comparison between the number of the ports PT and the number of the last packets LP received as well as the number of the middle packets MP received. FIG. 14 illustrates an example of operations of the packet reception unit PKTRCV.

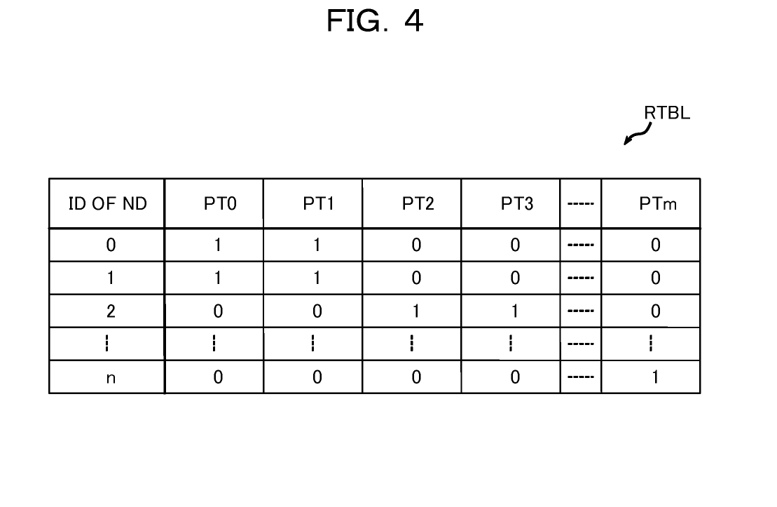

The routing table RTBL stores information indicating the port PT to be used to transmit data, for each of the nodes ND coupled to the network switches NWSW (FIG. 2). More specifically, the routing table RTBL stores information indicating the communication path CL that executes data transmission between the own node ND and another node ND. FIG. 4 illustrates an example of the routing table RTBL.

FIG. 4 illustrates an example of the routing table RTBL illustrated in FIG. 3. The routing table RTBL stores information indicating the port PT to be used to transmit data, for each of the IDs of the nodes ND0 to NDn included in the information processing system SYS1. In the routing table RTBL, “1” in the region corresponding to each of the ports PT indicates that the port PT is coupled to the communication path CL used to transmit a packet. In the routing table RTBL, “0” in the region corresponding to each of the ports PT indicates that the port PT is not coupled to the communication path CL and not used to transmit a packet. In the example illustrated in FIG. 4, transmission and reception of packets to and from the node ND0 are executed using the ports PT0 and PT1, while transmission and reception of packets to and from the node ND1 are executed using the ports PT0 and PT1. Meanwhile, transmission and reception of packets to and from the node ND2 are executed using the ports PT2 and PT3, while transmission and reception of packets to and from the node NDn are executed using the port PTm and any of the ports PT4 to PTm−1.

For example, the routing table RTBL is common among all the nodes ND0 to NDn. Thus, the node ND0 does not use the region corresponding to the node ND0 in the routing table RTBL, and the node ND1 does not use the region corresponding to the node ND1 in the routing table RTBL. The same goes for the other nodes ND2 to NDn. Note that the routing table RTBL may be provided so as to correspond to the packet transmission unit PKTSND and the packet reception unit PKTRCV, respectively.

FIG. 5 illustrates an example of write processing between the nodes ND illustrated in FIG. 2. In the example illustrated in FIG. 5, each of the packets is transmitted using two communication paths CL indicated by the solid line and the broken line. Note that the processing of the node ND illustrated in FIG. 5 is executed by the RDMA module.

The write processing is started when a write request is outputted to the RDMA module by the CPU in the data source node ND. The RDMA module reads data to be transmitted from the main storage device MEM in the own node ND, based on the information contained in the write request.

The data source node ND uses two communication paths CL to transmit the first packet FP containing the first data FD to the data destination node ND ((a) in FIG. 5). Next, the data source node ND uses two communication paths CL to sequentially transmit the middle packets MP (MP0 to MP3) containing the middle data MD (MD0 to MD3) to the data destination nodes ND, respectively ((b) and (c) in FIG. 5).

For example, the packet transmission unit PKTSND in the data source RDMA module sequentially selects two communication paths CL by use of a round-robin technique or the like, and sequentially transmits the middle packets MP0 to MP3 to the selected communication paths CL. Thereafter, the data source node ND uses the two communication paths CL to transmit the last packet LP containing the last data LD to the data destination node ND ((d) in FIG. 5).

In FIG. 5, a transmission delay of the communication path CL indicated by the broken line is larger than that of the communication path CL indicated by the solid line. The transmission delay of the communication path CL depends on the length of the communication path CL, the number of the network switches NWSW interposed between the communication paths CL, performance of the network switches NWSW, and the like.

The data destination node ND receives the first packet FP received through the communication path CL indicated by the solid line, and writes the first data FD contained in the received first packet FP into the main storage device MEM ((e) in FIG. 5). The data destination node ND discards the first packet FP received through the communication path CL indicated by the broken line.

Next, the data destination node ND sequentially receives the middle packets MP0 to MP3 through the two communication paths CL, and writes the middle data MD0 to MD3 contained in the middle packets MP into the main storage device MEM upon every receipt of the middle packet MP ((f) in FIG. 5). The transmission efficiency of the middle packets MP is improved by transmitting the middle packets MP0 to MP3 in parallel using the two communication paths CL, compared with the case of transmission thereof using a single communication path CL.

Next, the data destination node ND sequentially receives the last packets LP through the two communication paths CL, and writes the last data LD contained in the last packet LP received first into the main storage device MEM ((g) in FIG. 5). The data destination node ND discards the last packet LP received through the communication path CL indicated by the broken line. Note that the data destination node ND may write the last data LD contained in the last packet LP received last into the main storage device MEM.

The data destination node ND transmits a receipt acknowledgement packet ACK (or NAK) indicating whether or not the packets FP, MP0 to MP3, and LP may be received, to the data source node ND, based on the reception of two last packets LP through two communication paths CL ((h) in FIG. 5). The receipt acknowledgement packet ACK (or NAK) is transmitted using the communication path CL indicated by the solid line in FIG. 5, but may be transmitted using the communication path CL indicated by the broken line.

The receipt acknowledgement packet ACK indicates that the packets FP, MP0 to MP3, and LP have been normally received, while the receipt acknowledgement packet NAK indicates that at least one of the packets FP, MP0 to MP3, and LP has not been normally received. Then, the write processing is terminated based on the reception of the receipt acknowledgement packet ACK (or NAK) by the data source node ND.

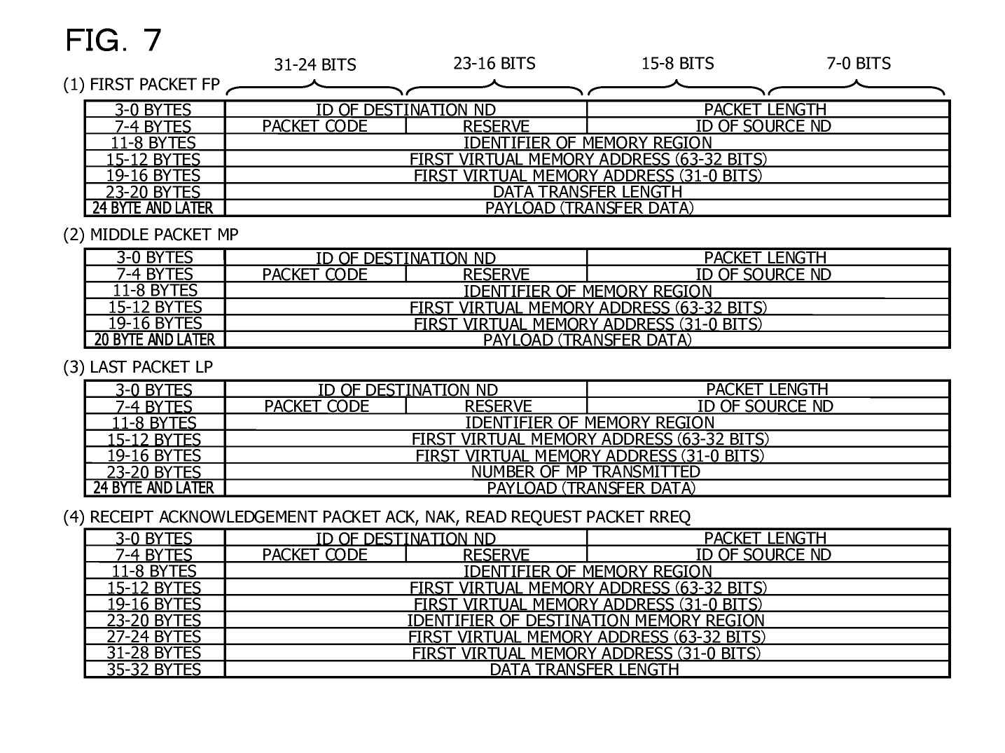

Note that each of the middle packets MP0 to MP3 contains information (a memory region identifier and a first virtual memory address) indicating a data storage location, as illustrated in FIG. 7. Thus, even when the data destination node ND receives the middle packet MP2 before the middle packet MP1, for example, the middle data MD2 and MD1 may be normally written into the main storage device MEM. Therefore, even when the reception order of the middle packets MP is switched, no transmission errors occur and packet retransmission processing or the like is not executed. Since the occurrence of transmission errors is suppressed, the packet transmission efficiency is improved.

FIG. 6 illustrates an example of read processing between the nodes illustrated in FIG. 2. As to the same or similar processing as or to that illustrated in FIG. 5, detailed description thereof is omitted. In the example illustrated in FIG. 6, again, each of the packets is transmitted using two communication paths CL indicated by the solid line and the broken line. Note that the processing of the node ND illustrated in FIG. 6 is executed by the RDMA module.

The read processing is started when a read request is outputted to the RDMA module by the CPU in the data destination node ND. The RDMA module generates a read request packet RREQ based on the information contained in the read request, and transmits the generated read request packet RREQ to the data source node ND ((a) in FIG. 6).

The data source node ND receives the read request packet RREQ, and reads the data from the main storage device MEM based on the information contained in the read request packet RREQ. Thereafter, as in the case of FIG. 5, the data source node ND transmits the first packet FP, the middle packets MP0 to MP3, and the last packet LP to the data destination node ND ((b), (c), (d), and (e) in FIG. 6). After receiving the last packets LP through the communication paths CL, the data destination node ND transmits a receipt acknowledgement packet ACK (or NAK) to the data source node ND ((f) in FIG. 6). Then, the read processing is terminated based on the reception of the receipt acknowledgement packet ACK (or NAK) by the data source node ND.

FIG. 7 illustrates an example of a format of each of the packets illustrated in FIGS. 5 and 6. The first packet FP has regions to store an ID (16 bits) of the destination node ND, a packet length (16 bits) of the first packet FP, a packet code (8 bits) indicating the type of the packet, and an ID (16 bits) of the source node ND. Note that “reserve” indicates a region not to be used. The first packet FP also has regions to store an identifier (32 bits) of the memory region, a first virtual memory address (64 bits), a data transfer length (32 bits) and a payload (transfer data; up to 128 bytes).

The middle packet MP has regions to store the ID of the destination node ND, a packet length of the middle packet MP, a packet code, the ID of the source node ND, an identifier of the memory region, a first virtual memory address and a payload.

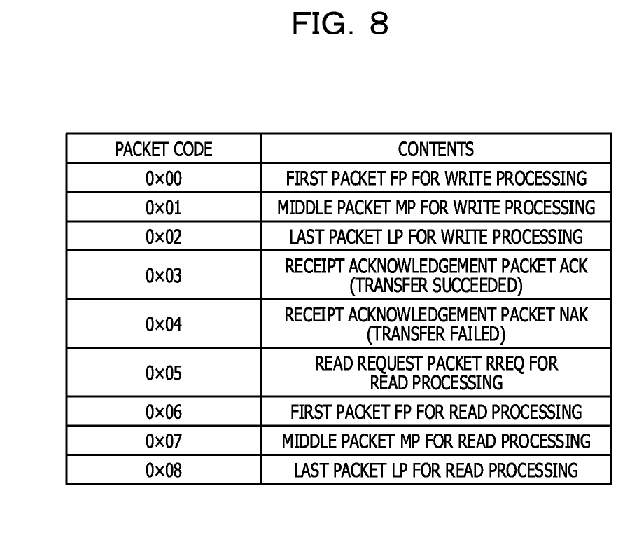

The last packet LP has regions to store the ID of the destination node ND, a packet length of the last packet LP, a packet code, the ID of the source node ND, an identifier of the memory region, a first virtual memory address, the number of the middle packets MP transmitted, and a payload. Note that the first packet FP, the middle packet MP, and the last packet LP may be sorted, respectively, into a packet for write processing and a packet for read processing, according to the values of packet codes illustrated in FIG. 8.

Each of the receipt acknowledgement packets ACK and NAK and the read request packet RREQ has regions to store the ID of the destination node ND, the packet length of each of the packets ACK, NAK, and RREQ, the packet code, and the ID of the source node ND. Each of the receipt acknowledgement packets ACK and NAK and the read request packet RREQ also has regions to store the identifier of the memory region of the destination, the first virtual memory address of the destination, the identifier of the memory region of the source, the first virtual memory address of the source, and the data transfer length.

“Destination” in the ID of the destination node ND and “source” in the ID of the source node ND indicate the data destination and the data source, respectively. More specifically, the node ND that receives data to be written into the main storage device MEM is the destination, while the node ND that transmits the data read from the main storage device MEM is the source.

The identifier of the memory region is stored to identify a memory region, into which data is to be written, among a plurality of memory regions in a memory space. The first virtual memory address is stored to specify a location in the main storage device MEM (included in the data destination node ND) to store data stored in a payload. The first virtual memory address is specified for each of the payloads contained in the packets FP, MP, and LP. Upon receipt of the packets FP, MP, and LP, the RDMA module obtains a physical address, at which data is to be written, based on the identifier of the memory region and the first virtual memory address.

The use of the packet formats illustrated in FIG. 7 may specify the first virtual memory address for each of the packets FP, MP, and LP, and a data write destination is independently obtained for each of the packets FP, MP and LP. As a result, even when the reception order of the middle packets MP is switched by transmitting the middle packets MP in parallel using the communication paths CL, the data contained in the middle packets MP is normally written into the main storage device MEM. On the other hand, when a relative value of an address indicating a write destination of the data stored in the first packet FP is stored in the middle packet MP and the last packet LP, the data is not written at an appropriate location in the main storage device MEM if the reception order of the packets is switched.

Note that, in the region for the transfer length of the data contained in the first packet FP, the receipt acknowledgement packets ACK and NAK, and the read request packet RREQ, the transfer length of the entire data to be transferred based on one write request or one read request is stored.

In the receipt acknowledgement packets ACK and NAK, the same value as that of the identifier of the memory region stored in the first packet FP is stored in the region for the identifier of the memory region of the destination. Moreover, in the receipt acknowledgement packets ACK and NAK, the same value as that of the first virtual memory address stored in the first packet FP is stored in the region for the first virtual memory address of the destination. Furthermore, in the receipt acknowledgement packets ACK and NAK, the same value as that of the transfer length of the data stored in the first packet FP is stored in the region for the data transfer length. Note that, in the receipt acknowledgement packets ACK and NAK, the regions for the identifier of the memory region of the source and the first virtual memory address of the source may not be used.

The identifier of the memory region of the source and the first virtual memory address of the source are used by the source node ND to obtain a physical address of the main storage device MEM, from which data is to be read, in the read request packet RREQ.

FIG. 8 illustrates an example of the packet codes illustrated in FIG. 7. “0x” attached before the numerical value of each packet code indicates that the numerical value is hexadecimal. The packet reception unit PKTRCV illustrated in FIG. 3 determines the type of each packet according to the value stored in the region for the packet code illustrated in FIG. 7. Then, the RDMA module executes write processing or read processing based on the packet type determined by the packet reception unit PKTRCV.

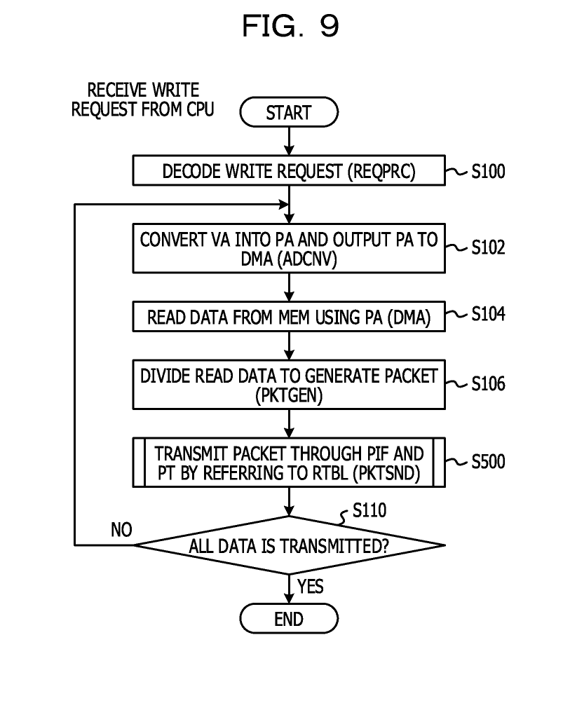

FIG. 9 illustrates an example of operations of the RDMA module as the data source in the write processing illustrated in FIG. 5. More specifically, FIG. 9 illustrates an operation of transmitting the data read from the main storage device MEM of the source to the destination node ND. The operation illustrated in FIG. 9 is started based on the reception of the write request from the CPU by the RDMA module as the data source.

First, in Step S100, the request processing unit REQPRC illustrated in FIG. 3 decodes the write request received from the CPU through the request reception unit REQRCV. The request processing unit REQPRC outputs information obtained by the decoding to the address conversion unit ADCNV. Next, in Step S102, the address conversion unit ADCNV converts the identification information to identify the memory region contained in the write request and the first virtual memory address (VA) of the data source into a physical address PA, and outputs the converted physical address PA to the transfer unit DMA.

Next, in Step S104, the transfer unit DMA reads data from the main storage device MEM using the physical address PA, and outputs the read data to the packet generation unit PKTGEN. Then, in Step S106, the packet generation unit PKTGEN divides the data read from the main storage device MEM to generate a packet containing the divided data. The packet generated by the packet generation unit PKTGEN is any of the first packet FP, the middle packet MP, and the last packet LP. The packet generation unit PKTGEN outputs the generated packet to the packet transmission unit PKTSND.

Thereafter, in Step S500, the packet transmission unit PKTSND determines a port PT, to which the packet is to be transmitted, by referring to the routing table RTBL. Then, the packet transmission unit PKTSND transmits the packet to the determined port PT through the port interface PIF. FIG. 13 illustrates an example of the operation executed by the packet transmission unit PKTSND in Step S500.

Next, in Step S110, the RDMA module determines whether or not all the data that responds to the write request has been transmitted. When all the data has been transmitted, that is, when the last packets LP have been transmitted, the RDMA module terminates the operation. On the other hand, when there is data yet to be transmitted, that is, when the last packet LP is not transmitted, the RDMA module moves the operation to Step S102.

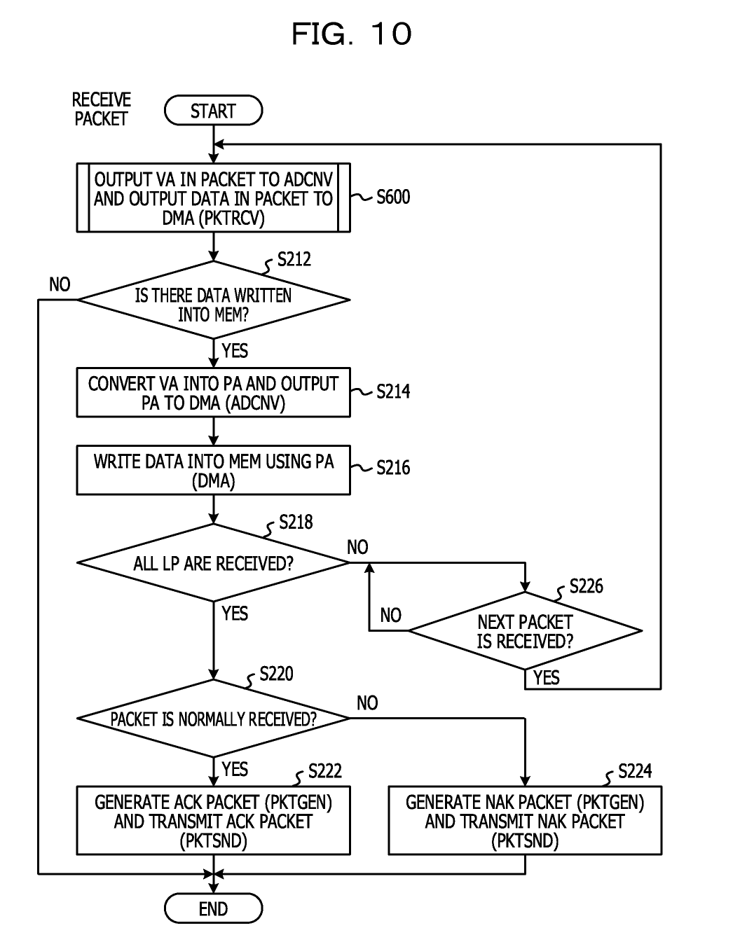

FIG. 10 illustrates an example of operations of the RDMA module as the data destination in the write processing illustrated in FIG. 5. More specifically, FIG. 10 illustrates an operation of writing the data contained in the packet received from the data source node ND into the main storage device MEM in the destination node ND. The operation illustrated in FIG. 10 is started based on the reception of the packet from the data source node ND by the RDMA module as the data destination.

First, in Step S600, the packet reception unit PKTRCV outputs the identifier of the memory region and the first virtual memory address (VA) contained in the received packet to the address conversion unit ADCNV. The packet reception unit PKTRCV also outputs the data contained in the received packet to the transfer unit DMA. FIG. 14 illustrates an example of the operation executed by the packet reception unit PKTRCV in Step S600.

Next, in Step S212, the RDMA module moves the operation to Step S214 when receiving the data to be written into the main storage device MEM in Step S600, or terminates the operation when receiving no data to be written into the main storage device MEM in Step S600.

In Step S214, the address conversion unit ADCNV converts the identifier of the memory region received from the packet reception unit PKTRCV and the first virtual memory address (VA) into a physical address PA, and outputs the converted physical address PA to the transfer unit DMA.

Next, in Step S216, the transfer unit DMA writes the received data into the main storage device MEM using the physical address PA. Then, in Step S218, the RDMA module moves the operation to Step S220 when receiving all the last packets LP, or moves the operation to Step S226 when not receiving all the last packets LP. In Step S226, the RDMA module wait for the next packet to be received, and moves the operation to Step S600 once the next packet is received.

When the first packet FP to the last packet LP are normally received in Step S220, the RDMA module moves the operation to Step S222. On the other hand, when the first packet FP to the last packet LP are not normally received, the RDMA module moves the operation to Step S224.

In Step S222, the packet generation unit PKTGEN generates a receipt acknowledgement packet ACK and outputs the generated receipt acknowledgement packet ACK to the packet transmission unit PKTSND. The packet transmission unit PKTSND terminates the operation after transmitting the receipt acknowledgement packet ACK from the packet generation unit PKTGEN to the data source node ND.

In Step S224, the packet generation unit PKTGEN generates a receipt acknowledgement packet NAK and outputs the generated receipt acknowledgement packet NAK to the packet transmission unit PKTSND. The packet transmission unit PKTSND terminates the operation after transmitting the receipt acknowledgement packet NAK from the packet generation unit PKTGEN to the data source node ND.

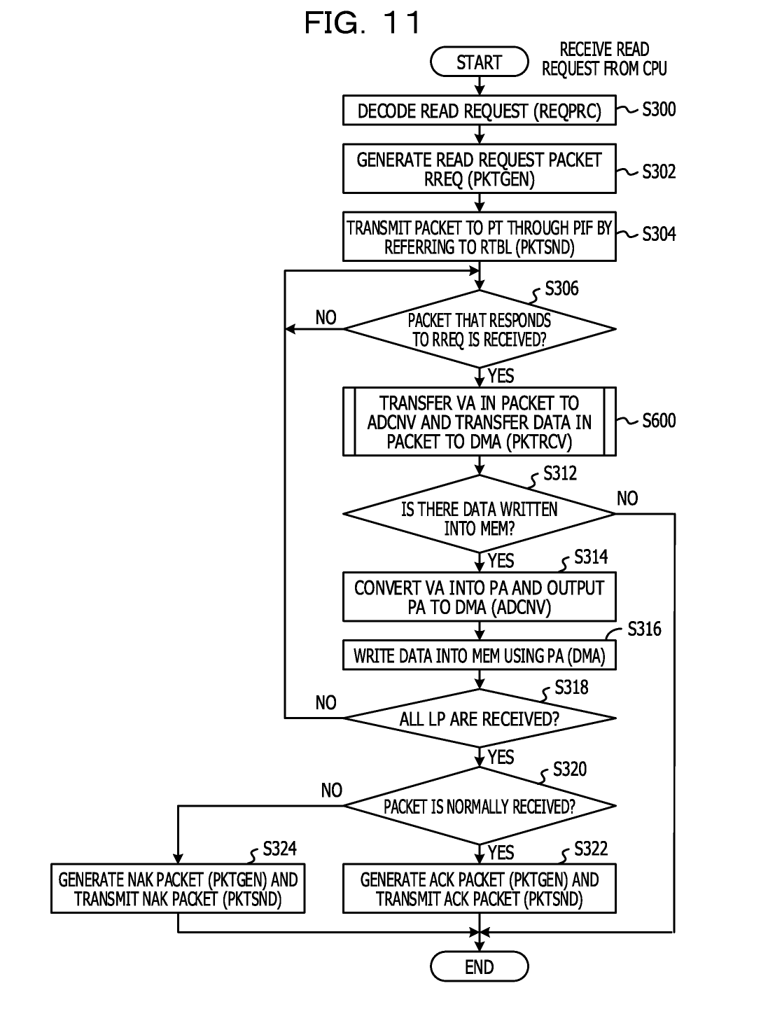

FIG. 11 illustrates an example of operations of the RDMA module as the data destination in the read processing illustrated in FIG. 6. More specifically, FIG. 11 illustrates operations of the data destination node ND issuing a read request packet RREQ (data transfer request) to the data source node ND and writing the data contained in the packet transmitted from the source node ND into the main storage device MEM. The operations illustrated in FIG. 11 are started based on the reception of the read request from the CPU by the RDMA module as the data destination.

First, in Step S300, the request processing unit REQPRC illustrated in FIG. 3 decodes the read request received from the CPU through the request reception unit REQRCV, and outputs the information contained in the read request to the packet generation unit PKTGEN.

Next, in Step S302, the packet generation unit PKTGEN generates a read request packet RREQ based on the information from the request processing unit REQPRC. As illustrated in FIG. 7, the read request packet RREQ contains the ID of the source node ND, the identifier of the memory region of the source, the first virtual memory address of the source, and the data transfer length. The packet generation unit PKTGEN outputs the generated read request packet RREQ to the packet transmission unit PKTSND.

Then, in Step S304, the packet transmission unit PKTSND determines a port PT, to which the read request packet RREQ is to be transmitted, by referring to the routing table RTBL based on the ID of the source node ND contained in the read request packet RREQ. Thereafter, the packet transmission unit PKTSND transmits the read request packet RREQ to the determined port PT through the port interface PIF.

Subsequently, in Step S306, the RDMA module waits for the packet reception unit PKTRCV to receive a packet that responds to the read request packet RREQ, and moves the operation to Step S600 when receiving the packet that responds to the read request packet RREQ.

In Step S600, the packet reception unit PKTRCV outputs the identifier of the memory region and the first virtual memory address (VA) contained in the received packet to the address conversion unit ADCNV. The packet reception unit PKTRCV also outputs the data contained in the received packet to the transfer unit DMA. FIG. 14 illustrates an example of the operation executed by the packet reception unit PKTRCV in Step S600.

The operation in Step S600 illustrated in FIG. 11 is the same as or similar to the operation in Step S600 illustrated in FIG. 10. The operations in Steps S312, S314, S316, S318, S320, S322, and S324 illustrated in FIG. 11 are the same as or similar to the operations in Steps S212, S214, S216, S218, S220, S222, and S224 illustrated in FIG. 10. More specifically, in Step S600 and Steps S312 to S324, the operation of receiving the packet transmitted from the source node ND and writing the data contained in the received packet into the main storage device MEM. Note that, when all the last packets LP are not received in Step S318, the RDMA module moves the operation to Step S306.

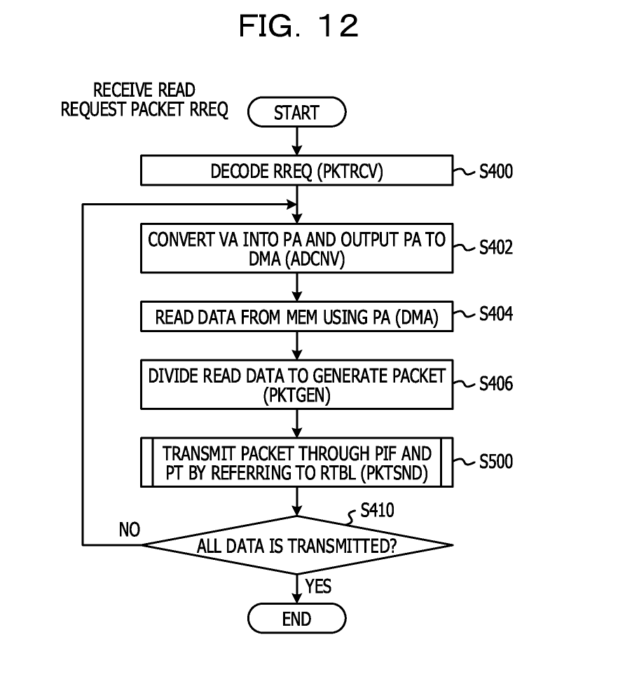

FIG. 12 illustrates an example of operations of the RDMA module as the data source in the read processing illustrated in FIG. 6. More specifically, FIG. 12 illustrates an operation of reading data from the main storage device MEM based on the read request packet RREQ received from the destination node ND, and transmitting the read data to the destination node ND.

First, in Step S400, the packet reception unit PKTRCV illustrated in FIG. 3 decodes the received read request packet RREQ. The packet reception unit PKTRCV outputs information obtained by the decoding to the address conversion unit ADCNV and the packet generation unit PKTGEN. Next, in Step S402, the address conversion unit ADCNV converts the identifier of the memory region of the source contained in the read request packet RREQ and the first virtual memory address (VA) of the source into a physical address PA. Then, the address conversion unit ADCNV outputs the converted physical address PA to the transfer unit DMA.

Thereafter, in Step S404, the transfer unit DMA reads data from the main storage device MEM using the physical address PA, and outputs the read data to the packet generation unit PKTGEN. The size of the data to be read from the main storage device MEM is the one indicated by the data transfer length contained in the read request packet RREQ.

Next, in Step S406, the packet generation unit PKTGEN divides the data read from the main storage device MEM to generate a packet containing the divided data. The packet to be generated contains the ID of the destination node ND, the ID of the source node ND, the identifier of the memory region of the destination, the first virtual memory address (VA) of the destination and the data transfer length, which are contained in the information from the packet reception unit PKTRCV. The packet generated by the packet generation unit PKTGEN is any of the first packet FP, the middle packet MP, and the last packet LP. The packet generation unit PKTGEN outputs the generated packet to the packet transmission unit PKTSND.

Then, in Step S500, the packet transmission unit PKTSND determines a port PT, to which the packet is to be transmitted, by referring to the routing table RTBL. Thereafter, the packet transmission unit PKTSND transmits the packet to the determined port PT through the port interface PIF. The operation in Step S500 illustrated in FIG. 12 is the same as or similar to the operation in Step S500 illustrated in FIG. 9. FIG. 13 illustrates an example of the operation executed by the packet transmission unit PKTSND in Step S500.

Next, in Step S410, the RDMA module determines whether or not all the data that responds to the read request packet RREQ has been transmitted. When all the data has been transmitted, that is, when the last packets LP have been transmitted, the RDMA module terminates the operation. On the other hand, when there is data yet to be transmitted, that is, when no last packet LP has been transmitted, the RDMA module moves the operation to Step S402.

FIG. 13 illustrates an example of the operation of the packet transmission unit PKTSND that executes Step S500 illustrated in FIGS. 9 and 12.

First, in Step S502, the packet transmission unit PKTSND determines ports PT, to which packets may be transmitted, by referring to the routing table RTBL, based on the ID of the source node ND contained in the packet from the packet generation unit PKTGEN. The routing table RTBL illustrated in FIG. 4 has information indicating the port PT coupled to the communication path CL for each node ND. Thus, the packet transmission unit PKTSND may acquire the number of the ports PT coupled to the source node ND by specifying the ID of the source node ND.

Next, in Step S504, the packet transmission unit PKTSND determines the packet type based on the packet code contained in the packet from the packet generation unit PKTGEN. The operation is moved to Step S506 when the packet is the first packet FP or the last packet LP, and is moved to Step S508 when the packet is the middle packet MP.

In Step S506, the packet transmission unit PKTSND terminates the operation after transmitting the first packet FP or the last packet LP to the ports PT determined in Step S502. In Step S508, on the other hand, the packet transmission unit PKTSND terminates the operation after transmitting the middle packet MP to any of the ports PT determined in Step S502.

FIG. 14 illustrates an example of the operation of the packet reception unit PKTRCV that executes Step S600 illustrated in FIGS. 10 and 11.

First, in Step S602, the packet reception unit PKTRCV moves the operation to Step S604 when the packet type is the first packet FP, or moves the operation to Step S612 when the packet type is not the first packet FP.

When a flag FFLG indicating that the first packet FP has been received is “0” (unreceived) in Step S604, the packet reception unit PKTRCV moves the operation to Step S606 to receive the first packet FP. On the other hand, when the flag FFLG is “1” (received), the packet reception unit PKTRCV moves the operation to Step S610 to discard the received first packet FP. Note that the flag FFLG is initialized to “0” at the start-up of the RDMA module.

In Step S606, the packet reception unit PKTRCV sets the flag FFLG to “1” (received), initializes a variable LAST indicating the number of the last packets LP received to “0”, and initializes a variable MIDL indicating the number of the middle packets MP received to “0”. Next, in Step S608, the packet reception unit PKTRCV outputs the identifier of the memory region and the first virtual memory address (VA) contained in the first packet FP to the address conversion unit ADCNV. The packet reception unit PKTRCV terminates the operation after outputting the data contained in the first packet FP to the transfer unit DMA.

In Step S610, the packet reception unit PKTRCV discards the received packet and terminates the operation.

In Step S612, the packet reception unit PKTRCV moves the operation to Step S614 when the packet type is the middle packet MP, or moves the operation to Step S618 when the packet type is not the middle packet MP.

In Step S614, the packet reception unit PKTRCV increases the variable MIDL by “1” and moves the operation to Step S616. In Step S616, the packet reception unit PKTRCV outputs the identifier of the memory region and the first virtual memory address (VA) contained in the middle packet MP to the address conversion unit ADCNV. The packet reception unit PKTRCV also outputs the data contained in the middle packet MP to the transfer unit DMA, and terminates the operation.

In Step S618, the packet reception unit PKTRCV moves the operation to Step S620 when the packet type is the last packet LP, or moves the operation to Step S610 when the packet type is not the last packet LP.

In Step S620, the packet reception unit PKTRCV acquires the number of ports PT coupled to the source node ND, based on the ID of the source node ND contained in the last packet LP, by referring to the routing table RTBL. In other words, the packet reception unit PKTRCV acquires the number of the last packets LP to be received from the destination node ND. The routing table RTBL illustrated in FIG. 4 has information indicating the port PT coupled to the communication path CL for each node ND. Thus, the packet reception unit PKTRCV may acquire the number of the ports PT coupled to the source node ND by specifying the ID of the source node ND. Next, in Step S622, the packet reception unit PKTRCV increases the variable LAST by “1” and moves the operation to Step S624.

In Step S624, the packet reception unit PKTRCV determines whether or not the variable LAST coincides with the number of the ports PT acquired in Step S620. When the variable LAST coincides with the number of the ports PT, the packet reception unit PKTRCV determines that all the last packets LP have been received from the destination node ND, and moves the operation to Step S626. On the other hand, when the variable LAST does not coincide with the number of the ports PT (LAST<number of PT), the packet reception unit PKTRCV determines that all the last packets LP have not been received from the destination node ND, and moves the operation to Step S610. In this case, the received last packet LP is discarded in Step S610.

By comparing the variable LAST with the number of the ports PT, it is determined whether or not all the last packets LP have been received, without depending on the number of communication paths CL to be used. Moreover, the determination of the reception of all the last packets LP indicates that all the middle packets MP separately transmitted to the communication paths CL have been received. As a result, even when the middle packet MP is transmitted through the communication paths CL, the middle packet MP is received without being lost, thereby suppressing occurrence of transmission errors and packet retransmission. Therefore, reduction in performance of the information processing system SYS1 is suppressed.

In Step S626, the packet reception unit PKTRCV initializes the flag FFLG to “0”, and moves the operation to Step S628. In Step S628, the packet reception unit PKTRCV outputs the identifier of the memory region and the first virtual memory address (VA) contained in the last packet LP received last to the address conversion unit ADCNV. The packet reception unit PKTRCV also outputs the data contained in the last packet LP received last to the transfer unit DMA.

Note that Step S628 may be executed when the variable LAST does not coincide with the number of the ports PT (that is, when the last packet LP is received first) in Step S624. In this case, the packet reception unit PKTRCV terminates the operation without executing Step S610 to discard the last packet LP.

Here, as illustrated in FIG. 7, the last packet LP contains information (the identifier of the memory region and the first virtual memory address) indicating the storage location of the data contained in the last packet LP. Thus, even when the last packet LP transmitted through one of the communication paths CL is received before the middle packet MP transmitted through the other communication path CL, the data contained in the last packet LP is written into the main storage device MEM. When the last packet LP is received first, the data is stored in the main storage device MEM, thereby shortening the time before completion of the storage of the data corresponding to the write request or the read request. As a result, even when the last packets LP are received through the communication paths CL, reduction in the performance of the information processing system SYS1 is suppressed.

Next, in Step S630, the packet reception unit PKTRCV determines whether or not the variable MIDL coincides with “the number of the middle packets MP transmitted” contained in the last packet LP. When the variable MIDL coincides with “the number of the middle packets MP transmitted”, the packet reception unit PKTRCV determines that all the packets that respond to the write request or the read request have been received, and moves the operation to Step S632. On the other hand, when the variable MIDL does not coincide with “the number of the middle packets MP transmitted”, the packet reception unit PKTRCV determines that there are packets yet to be received, and moves the operation to Step S634.

The packet reception unit PKTRCV notifies, in Step S632, the packet generation unit PKTGEN of the normal reception of all the packets, and then terminates the operation. When all the packets have been normally received, the receipt acknowledgement packet ACK is transmitted to the source node ND as illustrated in Step S222 in FIG. 10 and Step S322 in FIG. 11. In other words, the reception of all the packets is determined by comparing the variable MIDL with “the number of the middle packets MP transmitted” contained in the last packet LP. As a result, even when the middle packet MP transmitted through one of the communication paths CL is received after the last packet LP transmitted through the other communication path CL, the middle packet MP is received without being lost. More specifically, even when the packets are transmitted through the communication paths CL, occurrence of transmission errors and packet retransmission are suppressed. Thus, reduction in the performance of the information processing system SYS1 is suppressed.

Meanwhile, the packet reception unit PKTRCV notifies, in Step S634, the packet generation unit PKTGEN of the failure to normally receive any of the packets, and then terminates the operation. When any of the packets has not been received, the receipt acknowledgement packet NAK is transmitted to the source node ND as illustrated in Step S224 in FIG. 10 and Step S324 in FIG. 11.

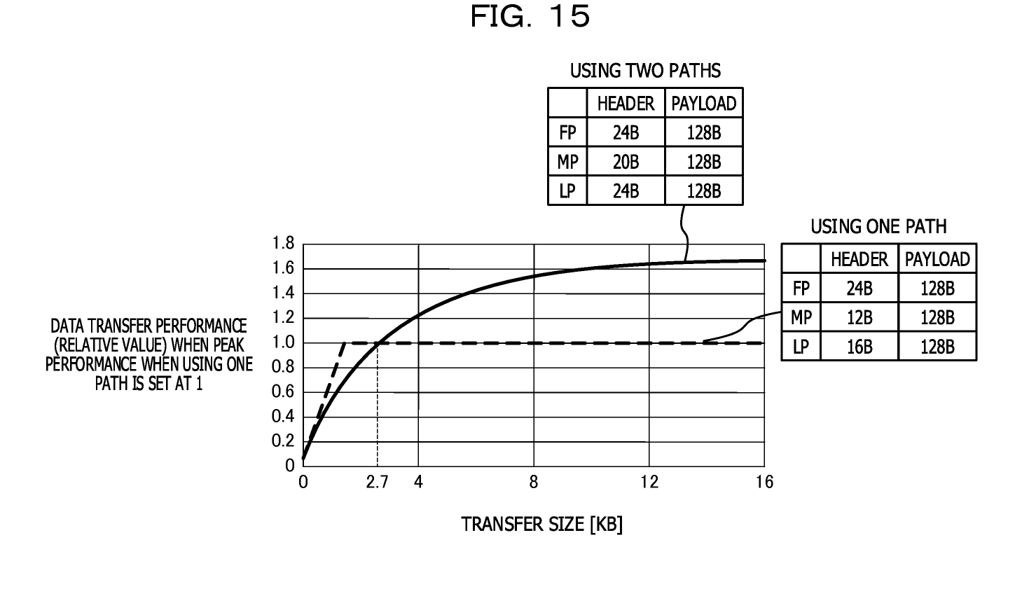

FIG. 15 illustrates an example of evaluation of data transfer performance in the information processing system SYS1 illustrated in FIG. 2. The heavy solid line indicates a simulation result of transfer performance when two communication paths CL are used, while the heavy broken line indicates a simulation result of transfer performance when one communication path CL is used. In the simulation, it is assumed that the band of one communication path CL is 26 GB/s (26 gigabytes per second) and a transmission delay of the communication path CL is 100 ns (nanosecond).

In the data transfer performance evaluation using the two communication paths CL, two first packets FP containing the same data, middle packets MP containing different data and two last packets LP containing the same data are repeatedly transferred to the two communication paths CL. Each of the first packets FP has a 24-byte header and a 128-byte payload. Each of the middle packets MP has a 20-byte header and a 128-byte payload. Each of the last packets LP has a 24-byte header and a 128-byte payload. Here, the header contains information other than the payload, in the first packet FP, the middle packet MP, and the last packet LP illustrated in FIG. 7.

In the data transfer evaluation using one communication path CL, the first packet FP, the middle packet MP, and the last packet LP are repeatedly transferred to the one communication path CL. The first packet FP has a 24-byte header and a 128-byte payload. The middle packet MP has a 12-byte header and a 128-byte payload. The last packet LP has a 16-byte header and a 128-byte payload.

When the transfer size is larger than 2.7 KB (kilobyte), the data transfer using two communication paths CL achieves higher performance than that achieved by the data transfer using one communication path CL. Note that the reason why the transfer performance is reversed at the transfer size of not more than 2.7 KB is because the use of one communication path CL enables back to back communication to transmit the next first packet FP before reception of a receipt acknowledgement packet ACK.

As for an amount of data to be transmitted between the nodes ND coupled to each other through the communication path CL, for example, the size (for example, 8 KB) of a cache memory included in the CPU is often used as a unit. In this case, there arises no problem with the transfer performance with the transfer size of not more than 2.7 KB.

Note that, although the transfer performance when the two communication paths CL are used is evaluated in FIG. 15, the transfer performance is further improved when packets are transmitted using three or more communication paths CL. When it is assumed that the number of packets to be transmitted by a conventional method using one communication path CL is N (N is 2 or more), the number of packets is increased by 2 (the first packet FP and the last packet LP) every time the number of the communication paths CL is increased by 1 in the method illustrated in FIGS. 1 to 14. However, by transmitting the middle packets MP in parallel using the communication paths CL, the transmission efficiency is improved every time the number of the communication paths CL is increased. When the number of the communication paths CL is M, the packet transmission efficiency (throughput) is the M-multiple of N/(N+2). For example, it is assumed that four packets (first packet FP, middle packets MP0 and MP1, and last packet LP) are transferred using one communication path CL. When the same data amount as that of the above is transferred using two communication paths CL by use of the method illustrated in FIG. 1, the number of packets is six (two first packets FP, middle packets MP0 and MP1, and two last packets LP). In this case, the transmission efficiency is “two times 4/6”, that is, 1.3 times.

In the above embodiment illustrated in FIGS. 2 to 15, again, the middle packets MP may be transmitted in parallel using the communication paths CL without generating any transmission error even when the communication paths CL have different transmission delays from each other, as in the case of the embodiment illustrated in FIG. 1. Since the occurrence of the transmission error is suppressed, reduction in packet transmission efficiency is suppressed.

Furthermore, in the embodiment illustrated in FIGS. 2 to 15, the middle packet MP contains address information indicating the data storage location. Thus, even when the reception order of the middle packets MP is switched, the occurrence of the transmission errors is suppressed. Thus, execution of packet retransmission processing and the like is suppressed, thereby improving the packet transmission efficiency.

The comparison between the variable LAST and the number of the ports PT makes it possible to determine whether or not all the last packets LP have been received, without depending on the number of the communication paths CL to be used. Thus, it is determined whether or not all the middle packets MP separately transmitted to the communication paths CL have been received. Likewise, by comparing the variable MIDL with “the number of the middle packets MP transmitted” contained in the last packet LP, it is determined that all the packets have been received. As a result, even when the middle packets MP are transmitted through the communication paths CL, the middle packets MP are received without being lost. Thus, the occurrence of transmission errors and packet retransmission are suppressed.

Note that two or more communication paths CL having a transmission delay smaller than those of the others may be selected from three or more communication paths CL, and packets may be transmitted by use of the method illustrated in FIGS. 1 to 14 using the selected communication paths CL.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a plurality of information processing apparatuses coupled to each other through a plurality of communication paths, the information processing apparatuses including at least a first information processing apparatus and a second information processing apparatus,
wherein
the first information processing apparatus includes
a first memory,
a first processor, and
a first controller configured to:
generate a plurality of leading packets, each including destination information to identify the second information processing apparatus in leading data among data read from the first memory based on a memory transfer request from the first processor, the second information processing apparatus being a destination of the data specified by the memory transfer request,
transmit the plurality of leading packets to the plurality of communication paths, respectively,
generate a plurality of last packets including the destination information in last data among the data read from the first memory based on the memory transfer request, and
transmit the plurality of last packets to the plurality of communication paths, respectively, and
the second information processing apparatus includes
a second memory, and
a second controller configured to:
count the last packets received through the plurality of communication paths, and
control to store the last data included in the received last packets in the second memory when the number of the last packets counted coincides with the number of the plurality of communication paths.

2. The information processing system according to claim 1, wherein the first controller is configured to:
generate a middle packet including destination information to identify the second information processing apparatus in middle data between the leading data and the last data among the data read from the first memory, and
transmit the middle packet to any of the plurality of communication paths.

3. The information processing system according to claim 2, wherein
the first controller is configured to transmit the middle packet to any of the communication paths sequentially selected among the plurality of communication paths.

4. The information processing system according to claim 2, wherein
the middle packet includes address information indicating a storage location address of the second memory to store the middle data, and
the second controller is configured to control to store the middle data at the storage location address indicated by the address information included in the middle packet, upon every receipt of the middle packet.

5. The information processing system according to claim 1, wherein
the second controller is configured to control to store, in the second memory, the last data included in the last packet received first among the plurality of last packets received, when the number of the last packets counted coincides with the number of the plurality of communication paths.

6. The information processing system according to claim 1, wherein
the second controller is configured to transmit a receipt acknowledgement to the first controller through one of the plurality of communication paths, when the number of the last packets counted coincides with the number of the plurality of communication paths.

7. The information processing system according to claim 1, wherein
the last packet includes transmission number information indicating the number of the middle packets transmitted to the plurality of communication paths, and
the second controller is configured to:
count the middle packets received through the plurality of communication paths, and
transmit a receipt acknowledgement to the first controller through one of the plurality of communication paths, when the number of the last packets counted coincides with the number of the plurality of communication paths and the number of the middle packets counted coincides with the number of the middle packets indicated by the transmission number information.

8. The information processing system according to claim 5, wherein
each of the plurality of information processing apparatuses includes a routing table storing communication path information indicating the plurality of communication paths to be used to transmit data, for each of the information processing apparatuses as a data source, and
the second controller is configured to obtain the number of the plurality of communication paths by referring to the routing table.

9. The information processing system according to claim 1, wherein
each of the plurality of information processing apparatuses includes a routing table storing communication path information indicating the plurality of communication paths to be used to transmit data, for each of the information processing apparatuses as a data destination, and
the first controller is configured to select a communication path to transmit the leading packet and the last packet among the plurality of communication paths by referring to the routing table.

10. The information processing system according to claim 1, wherein
the last packet includes address information indicating a storage location address of the second main storage device to store the last data, and
the second controller is configured to control to store the last data at the storage location address indicated by the address information included in the last packet received.

11. A method of controlling an information processing system including a plurality of information processing apparatuses coupled to each other through a plurality of communication paths, the information processing apparatuses including at least a first information processing apparatus and a second information processing apparatus, the method comprising:
generating, by the first information processing apparatus, a plurality of leading packets, each including destination information to identify the second information processing apparatus in leading data among data read from a first memory of the first information processing apparatus based on a memory transfer request from the first processor, the second information processing apparatus being a destination of the data specified by the memory transfer request;
transmitting, by the first information processing apparatus, the plurality of leading packets to the plurality of communication paths, respectively;
generating, by the first information processing apparatus, a plurality of last packets including the destination information in last data among the data read from the first memory based on the memory transfer request;
transmitting, by the first information processing apparatus, the plurality of last packets to the plurality of communication paths, respectively;
counting, by the second information processing apparatus, the last packets received through the plurality of communication paths; and
controlling, by the second information processing apparatus, to store the last data included in the received last packets in a second memory of the second information processing apparatus when the number of the last packets counted coincides with the number of the plurality of communication paths.

12. The method according to claim 11, further comprising:
generating, by the first information processing apparatus, a middle packet including destination information to identify the second information processing apparatus in middle data between the leading data and the last data among the data read from the first memory; and
transmitting, by the first information processing apparatus, the middle packet to any of the plurality of communication paths.

13. The method according to claim 12, wherein the transmitting of the middle packet transmits the middle packet to any of the communication paths sequentially selected among the plurality of communication paths.

14. The method according to claim 12, wherein
the middle packet includes address information indicating a storage location address of the second memory to store the middle data, and
the controlling controls to store the middle data at the storage location address indicated by the address information included in the middle packet, upon every receipt of the middle packet.

15. The method according to claim 11, wherein the controlling controls to store, in the second memory, the last data included in the last packet received first among the plurality of last packets received, when the number of the last packets counted coincides with the number of the plurality of communication paths.

16. The method according to claim 11, further comprising:
transmitting, by the second information processing apparatus, a receipt acknowledgement to the first controller through one of the plurality of communication paths, when the number of the last packets counted coincides with the number of the plurality of communication paths.

17. The method according to claim 11, wherein the last packet includes transmission number information indicating the number of the middle packets transmitted to the plurality of communication paths, and
the method further comprising:
counting, by the second information processing apparatus, the middle packets received through the plurality of communication paths; and
transmitting, by the second information processing apparatus, a receipt acknowledgement to the first information processing apparatus through one of the plurality of communication paths, when the number of the last packets counted coincides with the number of the plurality of communication paths and the number of the middle packets counted coincides with the number of the middle packets indicated by the transmission number information.

18. The method according to claim 11, wherein each of the plurality of information processing apparatuses includes a routing table storing communication path information indicating the plurality of communication paths to be used to transmit data, for each of the information processing apparatuses as a data destination, and
the method further comprising:
selecting, by the first information processing apparatus, a communication path to transmit the leading packet and the last packet among the plurality of communication paths by referring to the routing table.

19. The method according to claim 11, wherein
the last packet includes address information indicating a storage location address of the second main storage device to store the last data, and
the controlling controls to store the last data at the storage location address indicated by the address information included in the last packet received.

20. An information processing apparatus configured to couple to another information processing apparatus through a plurality of communication paths, the information processing apparatus comprising:
a memory; and
a processor coupled to the memory and configured to:
count the last packets received from the another information processing apparatus through the plurality of communication paths, the another information processing apparatus executing a process including generating a plurality of leading packets, each including destination information to identify the information processing apparatus in leading data among data read from a memory of the another information processing apparatus based on a memory transfer request, the memory transfer request specifying the information processing apparatus as a destination of the data, transmitting the plurality of leading packets to the plurality of communication paths, respectively, generating a plurality of last packets including the destination information in last data among the data read from the memory of the another information processing apparatus based on the memory transfer request, and transmitting the plurality of last packets to the plurality of communication paths, respectively, and
control to store the last data included in the received last packets in the second memory when the number of the last packets counted coincides with the number of the plurality of communication paths.
